(19) United States
(12) Patent Application Publication
(10) Pub. No.: US 2022/0050073 A1
(43) Pub. Date: Feb. 17, 2022

(54) SYSTEM FOR DETECTING AN EVOLUTION OF AN ENVIRONMENTAL PARAMETER

(71) Applicant: COMMISSARIAT A L'ENERGIE ATOMIQUE ET AUX ENERGIES ALTERNATIVES, Paris (FR)

(72) Inventor: Thierry THOMAS, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/415,503

(22) PCT Filed: Dec. 23, 2019
(86) PCT No.: PCT/EP2019/086954

§ 371 Date: Jun. 17, 2021

(30) Foreign Application Priority Data
Dec. 21, 2018 (FR) 1874047

(51) Int. Cl. G01N 27/22; G06K 19/07

(52) U.S. Cl. CPC G01N 27/22; G06K 19/0717

(57) ABSTRACT

The invention relates to a system for detecting the evolution of an environmental parameter (1), comprising:
at least one detection module (12) including an LC resonant circuit responsive to an evolution of said environmental parameter, configured to operate, as a function of the value of said environmental parameter, either in a first mode, in which said resonant circuit has a resonance frequency within a predefined range for which the detection module is detectable by magnetic coupling by excitation in said range, or in a second mode, in which said resonant circuit has a resonance frequency outside said range or an absence of resonance frequency;
a declaration module (11) arranged in proximity to said detection module (12), configured to communicate without near-field contact even in the event of a variation in the value of said environmental parameter, and configured to declare the presence of the detection module.

The invention relates to systems for the remote detection of a change in the state of an object caused by its environment or in the environment close to the object, in particular using resonant circuits.

In a certain number of applications, it is important to be able to detect a change of state of the environment. In particular for safety reasons, it may be important to detect the occurrence of a pollutant in an industrial environment or else to detect the presence of liquid in a supposedly sealed medium inside the wall of a pipe. In particular, for flexible oil production pipes used at sea, it may prove essential to detect the occurrence of water in supposedly sealed areas. Specifically, the unwanted occurrence of water in the wall of a flexible pipe may cause corrosion phenomena of the metal reinforcement layers of the pipe, which is subsequently accompanied by accelerated degradation of the pipe.

Document U.S. Pat. No. 6,025,725 describes a detection system comprising a readout device and a detection module. The readout device includes an interrogation antenna coil. The detection device is an LC passive resonant circuit. The readout device is linked to the electrical state of the detection module through inductive coupling.

The resonant circuit from this document is sensitive to a physical parameter of the environment. Environmental parameters thus alter the electrical parameters of the resonant circuit of the detection device, for example by altering its resonant frequency. In one example, the detection device comprises a substrate that is folded so as to have two opposing faces. Each face has a plurality of conductive windings, the windings of the two faces being interconnected so as to form a resonant circuit. The two faces of the substrate are separated by a dielectric layer. The dielectric layer that is chosen in one example is sensitive to humidity. The variation in the properties of this dielectric layer alters the resonant frequency of the resonant circuit.

One drawback of this device is that, in the case of gradual modification of an LC resonant circuit based on the environmental physical parameter to be monitored, this may be in competition with parasitic modifications that are caused by a challenging, uncontrolled environment.

Another drawback of this device is that, in the case of a significant modification of the resonant circuit based on the environmental physical parameter to be monitored, the detection device is not able to be tested or identified for this state.

Lastly, if the resonator is impacted by multiple environmental physical parameters, the effect is accumulated on one and the same resonator, thereby making it impossible to discriminate between the various parameters. Although it may be possible to contemplate impacting two electrical parameters of the resonator, such as the resonant frequency and the quality factor for example, this remains limited and relatively indiscriminate.

The invention aims to overcome one or more of these drawbacks. The invention thus relates to a detection system for detecting the evolution of an environmental parameter, as defined in the appended claims.

The invention also relates to the variants of the dependent claims. A person skilled in the art will understand that each of the features in the description and in the dependent claims may be independently combined with the features of an independent claim without, however, constituting an intermediate generalization.

The invention also relates to a system comprising a flexible pipe and a detection system as defined above, in which said detection module and said declaration module are fixed in the thickness of the pipe near its outer surface.

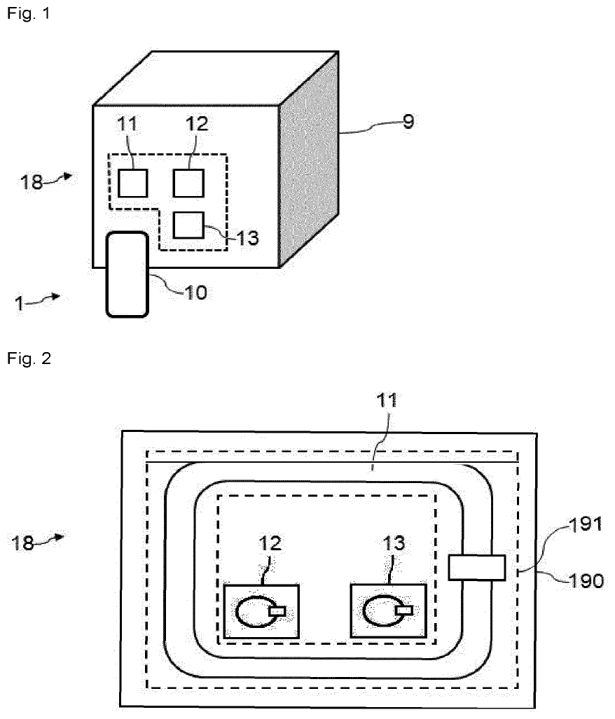

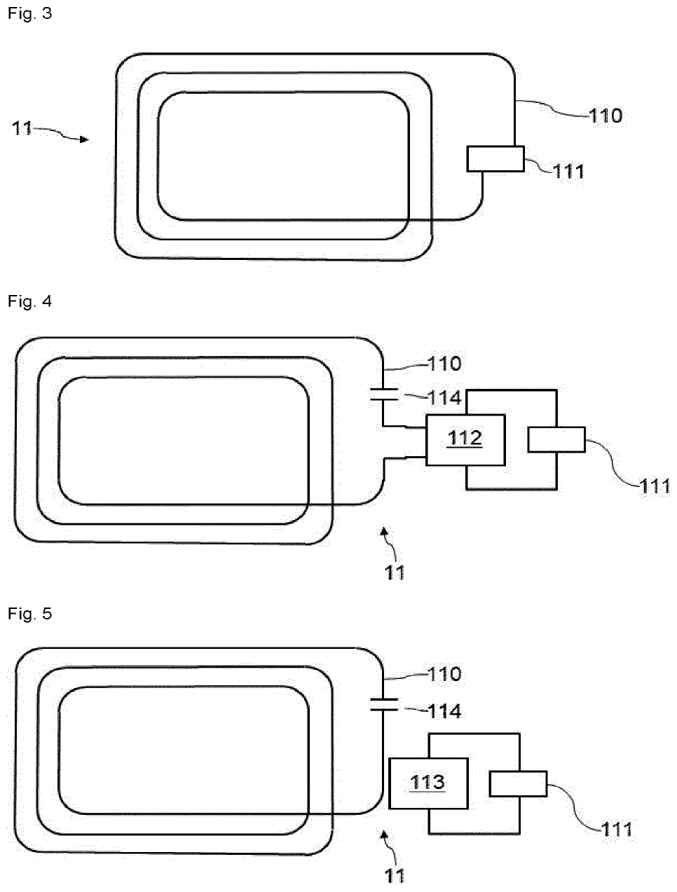

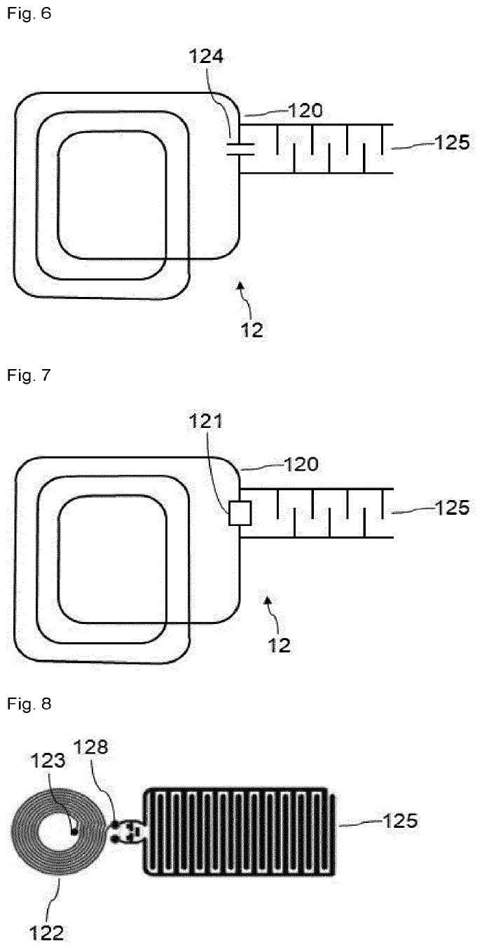

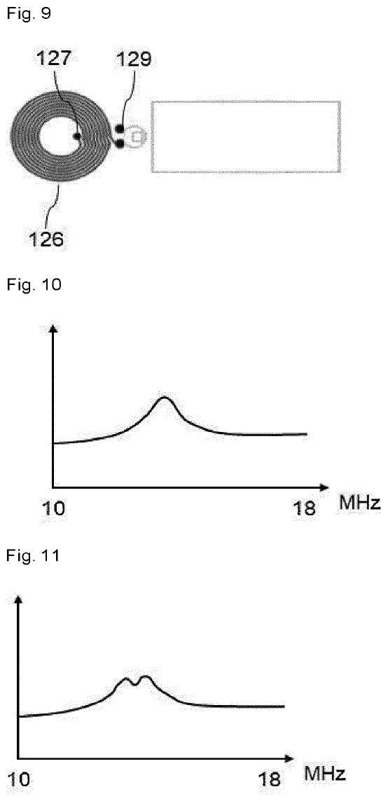

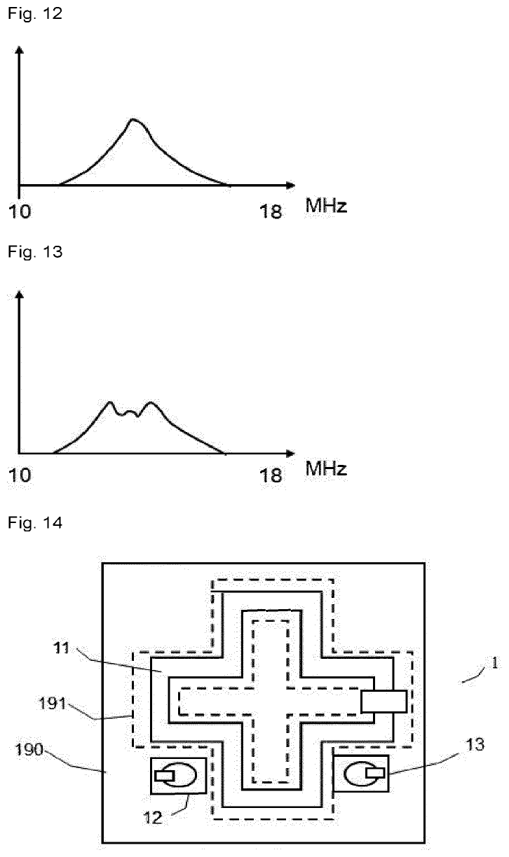

Other features and advantages of the invention will become clearly apparent from the completely non-limiting description thereof that is given below, by way of indication, with reference to the appended drawings, in which:

[FIG. 1] is a schematic view of a detection system for detecting the evolution of an environmental parameter according to one embodiment of the invention;

[FIG. 2] is a schematic depiction of a variant of a detection block of a detection system according to one embodiment of the invention;

[FIG. 3] is a schematic depiction of a declaration module according to one exemplary implementation;

[FIG. 4] is a schematic depiction of a declaration module according to another exemplary implementation;

[FIG. 5] is a schematic depiction of a declaration module according to another exemplary implementation;

[FIG. 6] is a schematic depiction of a detection module according to one exemplary implementation;

[FIG. 7] is a schematic depiction of a detection module according to another exemplary implementation;

[FIG. 8] and

[FIG. 9] illustrate conductor tracks able to be produced on two faces of a substrate so as to form detection modules according to the examples of FIG. 6 or 7;

[FIG. 10] and

[FIG. 11] are graphs illustrating the frequency responses of a detection module as a function of its mode;

[FIG. 12] and

[FIG. 13] are graphs illustrating the frequency responses of a detection block as a function of its mode;

[FIG. 14] is a schematic depiction of another variant of a detection block of a detection system according to one embodiment of the invention.

FIG. 1 is a schematic view of a detection system 1 for detecting the evolution of an environmental parameter according to one embodiment of the invention. The detection system 1 in this case comprises a detection block 18 fixed to an object 9, and a near-field contactless readout device 10. The detection block 18 of the detection system 1 in this case comprises a declaration module 11, a detection module 12 and a detection module 13. The detection modules 12 and 13 and the declaration module 11 are separate, without any electrical connection between them. The detection modules 12 and 13 and the declaration module 11 are fixed to an object 9 for which it is desired to evaluate the evolution of one or more environmental parameters. The detection modules 12 and 13 are arranged near the declaration module 11.

The invention proposes a detection system 1 in which the declaration module 11 is configured so as to be able to be detected by the nearby readout device 10 while being relatively unaffected or not affected by the variation in the environmental parameter to be studied. By virtue of its presence detection, the declaration module 11 may be configured so as to declare the presence of the nearby detection modules 12 and 13. The declaration module 11 is thus configured so as to communicate contactlessly in near-field mode with the readout device 10, independently of said environmental parameter.

The invention proposes a detection system 1 in which one or more detection modules 12 or 13 each include an LC resonant circuit, sensitive to the evolution of an environmental parameter to be studied. Such an LC resonant circuit thus has first and second operating modes, depending on the value of the environmental parameter to be studied:
a first operating mode in which this resonant circuit has a resonant frequency contained within a predefined range. In this nominal operating mode, the resonant frequency is not altered to a sufficient extent by a variation in the environmental parameter;
a second operating mode in which this resonant circuit has a resonant frequency outside said range or does not have a resonant frequency. This second mode makes it possible to witness the variation in an environmental parameter.

Inverse logic of the first and second operating modes may also be contemplated: the absence of a resonant frequency or the resonant frequency outside a range may be attributed to the second operating mode.

The predefined range of the resonant frequency of the LC resonant circuit may range from 0.9*f0 to 1.1*f0, for example, or else from 0.8*f0 to 1.210, where f0 is the nominal resonant frequency (corresponding to the resonant frequency of the LC resonant circuit under normal usage conditions) of the LC resonant circuit.

The detection system 1 is advantageously based on all-or-nothing detection of the detection modules 12 and 13. The all-or-nothing detection principle is based on a ‘significant’ variation in a passive electrical element, for example a conductor track, a resistive track or a capacitance, following a change of the environment close to this electrical element. The variation in the passive electrical element may be reversible or irreversible. The detection modules 12 and 13 may thus operate in all-or-nothing mode, depending on their operating mode.

Such all-or-nothing operation proves to be particularly useful, in particular if the electromagnetic environment is variable or subjected to interference and thus prevents detection of a limited variation in the resonant frequency of the detection modules 12 or 13. Using all-or-nothing detection, it is possible to robustly detect whether the detection modules 12 or 13 are in a first or a second operating mode. The detection modules 12 and 13 may be sensitive to different environmental parameters.

Depending on the environmental parameter to be studied, an electrical component may exhibit a breakage (for example a fuse) or a strong variation in an electrical characteristic, so as to alter the resonant frequency of the resonant circuit by at least a factor of 2, preferably by a factor of 5.

Changes of state of the environment close to the detection modules 12 or 13 are for example those that may lead to the corrosion of metal elements forming part of the structure of the object 9 with which the detection system 1 may be associated. This may involve in particular infiltration of water (fresh water or salt water) or corrosive gases (H₂S) or gases that are unwanted for certain applications (CO₂).

The detection system 1 may use the technical principles of passive RFID tags for the data exchange mode and for the remote power supply-based electric power supply mode.

The data communication and the remote power supply may thus invoke the technical solutions of RFID tags, in particular LF or HF RFID tags using an inductive radiofrequency link. This technology is used by standardized identification systems, for example systems in accordance with the standards ISO14443, ISO15693 and ISO18000-3 at the frequency of 13.56 MHz, and ISO18000-2 at a frequency below 150 kHz.

The frequency domain may extend from the low-frequency domain (LF: 30 kHz-300 kHz) to the high-frequency domain (HF: 3 MHz-30 MHz). The antennas then typically form an LC resonant circuit, the inductance L being formed by a coil whose geometry forms the condition for the coupling with the electromagnetic field (called antenna circuit in the remainder of the text), the capacitance C being able to be integrated (even partially) into an integrated circuit.

FIG. 2 is a schematic depiction of a detection block 18 of a system 1 including a declaration module 11 and detection modules 12 and 13 according to one embodiment of the invention. The modules 11 to 13 are in this case formed on one and the same substrate 190, for example a flexible plastic film. Forming the modules 11 to 13 on one and the same substrate makes it possible to arrange these modules accurately with respect to one another and makes it possible to reduce the manufacturing cost of the system 1. In order to ensure that it is protected and immune from one or more environmental parameters to be studied, the declaration module 11 is protected in an area 191 (illustrated in broken lines). The module 11 may thus be sealed between a protective film and the substrate 190. It is possible for example to use a thin protective film on the area 191, for example with a thickness of 0.1 mm, in order to promote the compactness of the detection block 18 of the system 1 that has to be associated with an object 9. The module 11 houses the modules 12 and 13 in the middle part of its antenna circuit. The area 191 provides an opening in which the modules 12 and 13 are arranged, and therefore not covered by the area 191, while still being near the module 11. The modules 12 and 13 are thus exposed to the environmental parameter, for example by being exposed to a fluid that may or may not include a pollutant to be detected. The modules 12 and 13, or at least one of their electrical components, are not covered by a protective film. It may also be contemplated for the devices 12 and 13 to be arranged at the periphery of the area 191.

In this example, the module 11 has an antenna circuit by way of which this module 11 is configured so as to communicate with the reader 10. The antenna circuit of the module 11 may be magnetically coupled with antenna circuits of the modules 12 and 13. The antenna circuit of the module 11 may serve as a relay antenna for the detection modules 12 and 13, which may be provided with resonant antenna circuits of far smaller sizes. It is thus possible to improve the range of the antennas of the modules 12 and 13, even with smaller sizes.

The declaration module 11 may have an antenna circuit associated with an RFID chip that is always operational. This antenna circuit is an LC resonator. This RFID chip is a primary RFID chip, the operation of which is not degraded by changes of state of the environment to be detected.

The antenna circuits of the detection modules 12 and 13 each form an LC resonator. This LC resonator is greatly modified by one of the changes of state of the environment to be detected (strong variation in its resonant frequency or strong reduction in its quality factor). This resonator may be a simple passive LC circuit, and the change of state may then be detected upon analyzing the form of its frequency response. This change of state of the environment to be detected may also lead to the resonator changing from a second operating mode to the first operating mode.

The detection module 12 (or 13) may also include an RFID chip connected to the LC resonator. The change of state of the environment may be detected upon the possible reading, or lack thereof, of the identifier of the RFID chip connected to the resonator of the detection module 12.

The reader 10 reading the identifier of the RFID chip of the declaration module 11 makes it possible to confirm that this module 11 is present (and therefore that the detection block 18 of the detection system 1 is present) in the absence of any response from the detection modules 12 and 13, in order to avoid a false diagnosis corresponding to a search that might be performed by the reader 10 at the incorrect location, at a distance from the declaration module 11.

In one preferred embodiment of the invention, during a read operation by the reader 10 near the detection block 18, the declaration module 11 transmits all of the information relating to its immediate environment, and in particular the identifiers of the RFID chips of the detection modules 12 and 13 associated therewith, to the reader 10. The reader 10 thus knows all of the identifiers of detection modules to be sought in close proximity to the declaration module 11. Depending on the detection modules recognized or not recognized by the reader 10, it is possible to deduce the operating mode of each of the detection modules associated with the declaration module 11 that are currently being read.

The absence of any response from the declaration module 11 corresponds either to the absence thereof near the reader 10 or to malfunctioning thereof.

FIG. 14 illustrates one variant embodiment in which the modules 12 and 13 are arranged at the periphery of the area 191. In this variant, the antenna circuit of the module 11 follows a cross shape, and the detection modules 12 and 13 are placed near this antenna circuit, outside the area 191.

It should be noted that the shape of the area 191 could also be provided such that one of the detection modules 12-13 is placed in an opening in the center of this area, and that another of the detection modules 12-13 is placed at the periphery.

FIG. 3 is a schematic depiction of a declaration module 11 according to one exemplary implementation. In this example, the module 11 includes an LC resonator. The module 11 is in this case provided with an RFID chip 111. The chip 111 is configured so as to provide an identifier of the module 11, and possibly an identifier of the associated detection modules 12 and 13, upon a request from the reader 10. In this case, the chip 111 may contain an identifier of the associated detection modules 12 and 13 corresponding to their unique identifier stored in their associated RFID chip, or else a second identifier that is not unique if all possible detection module identifiers are considered, but that is uniquely associated with the chip 111 of the declaration module 11.

The chip 111 may also contain information with regard to the characteristics of the LC circuit of the detection modules that are associated therewith, or else information with regard to the operating modes of these detection modules. The reader 10 thus retrieves, at the same time as the identifiers of the detection modules linked to the declaration module 11, information about their characteristics and is able to deduce characteristics regarding the close environment directly therefrom, from the detection or lack of detection of a detection module.

The LC resonator in this case includes a winding 110 consisting of a plurality of turns, forming an antenna circuit and an inductor for the LC resonator. The winding 110 may have an area of 100 cm² in order to promote communication with the reader 10. The winding 110 is in this case connected to the terminals of the RFID chip 111. The RFID chip 111 may include an integrated capacitance for the LC resonator (for example of 23.5 pF, or else 97 pF). The capacitance will for example be defined so as to be as robust as possible to the environment for the declaration module 11, for example by having a relatively high value of 97 pF. The capacitance will for example be of a lower value for the detection modules 12 and 13, for example 23.5 pF. The LC resonator of the module 11 is insensitive or relatively insensitive to variations in the environmental parameter to be studied.

FIG. 4 is a schematic depiction of a declaration module 11 according to another exemplary implementation. In this example, the module 11 also includes an LC resonator. The module 11 is in this case also provided with an RFID chip 111. The chip 111 is configured so as to provide an identifier of the module 11, and possibly an identifier of the associated detection modules 12 and 13, upon a request from the reader 10. The LC resonator in this case includes a winding 110 consisting of a plurality of turns, forming an antenna circuit and an inductor for the LC resonator. The winding 110 is connected to a capacitor 114.

The winding 110 is in this case connected to a matching circuit 112. The chip 111 is also connected to the terminals of the matching circuit 112. The winding 110 and the capacitor 114 may form a primary LC resonator. A self-resonant inductive antenna, as described in document FR2961353, may in particular be used. Such an antenna is particularly suitable for use in a humid environment, with a resonant frequency that is relatively unaffected by nearby variations in humidity. The matching circuit 112 may include a smaller winding so as to form a resonant circuit with the RFID chip 111, and possibly so as to allow the chip 111 to be matched to the primary LC resonator. The LC resonators of the module 11 are insensitive or relatively insensitive to variations in the environmental parameter to be studied.

FIG. 5 is a schematic depiction of a declaration module 11 according to another exemplary implementation. In this example, the module 11 also includes an LC resonator. The module 11 is in this case also provided with an RFID chip 111. The chip 111 is configured so as to provide an identifier of the module 11, and possibly an identifier of the associated detection modules 12 and 13, upon a request from the reader 10. The LC resonator in this case includes a winding 110 consisting of a plurality of turns, forming an antenna circuit and an inductor for the LC resonator. The winding 110 is connected to a capacitor 114.

The winding 110 is in this case magnetically coupled to a matching circuit 113. The chip 111 is connected to the terminals of the matching circuit 113. The winding 110 and the capacitor 114 may form a primary LC resonator. The matching circuit 113 may include a smaller winding so as to form a resonant circuit with the RFID chip 111, and possibly so as to allow the chip 111 to be matched to the primary LC resonator. The LC resonators of the module 11 are insensitive or relatively insensitive to variations in the environmental parameter to be studied.

FIG. 6 is a schematic depiction of a detection module 12 according to one exemplary implementation. In this example, the module 12 takes the form of an LC resonator. The module 12 in this case does not have an RFID chip. The module 12 in this case comprises a winding 120 consisting of a plurality of conductive turns, intended to form the inductor of the LC circuit. The winding 120 is in this case connected to the terminals of a capacitor 124. The capacitor 124 is insensitive or relatively insensitive to variations in the environmental parameter to be studied. The structure of the capacitor 124 may for example be protected from the environmental parameter by one or more appropriate protective layers. The capacitor 124 in this case forms a fixed part of the capacitance of the LC circuit. An additional capacitor 125 is connected to the terminals of the capacitor 124 described above. This additional capacitor 125 is sensitive to variations in the environmental parameter. The additional capacitor 125 may for example be brought into contact with a fluid in which it is desired to detect the variation in the environmental parameter. The additional capacitor 125 may for example have a part that is not covered by a protective layer. The additional capacitor 125 in this case has a comb-shaped geometry, with interdigitated metal lines, such that its capacitance is strongly dependent on the electrical characteristics of the nearby medium or of a fluid in contact therewith. The capacitor 125 may for example be brought into electrical contact with a fluid in which it is desired to detect the variation in the environmental parameter, or else be placed in the close presence of the fluid and electrically insulated therefrom by an insulating layer of low thickness that provides galvanic isolation.

An application to the detection of water may for example be described. Water (fresh water or salt water) is characterized by a high dielectric constant (ϵᵣ=ϵ/ϵo˜80). Water containing salts in solution is characterized by an electrical conductivity that increases in line with salt concentration.

A capacitor with a comb-shaped geometry has a capacitance dependent on the dielectric constant of nearby materials, and losses in capacitance (parallel resistance) are dependent on the conductivity of nearby materials (in a more significant manner if there is electrical contact with the material). The comb-shaped geometry of the capacitor 125 allows the equivalent of a capacitor formed by two parallel lines of greater length, practically the equivalent of the extended length of the meander formed in the comb-shaped geometry, around 25 cm for an example such as the one in FIG. 8 described below.

The capacitance between two parallel metal lines is proportional to the dielectric constant of the material bathing these two lines. The thickness of material around the metal lines contributing to the capacitance value is practically of the order of the spacing between the two lines. The capacitance value in a ‘vacuum’ is of the order of around 10 pF to 30 pF per meter of line, depending on the ratio between the width of the lines and the spacing between them. This capacitance value is multiplied by a factor of several tens when the material around the metal lines is impregnated with water (dielectric constant ϵᵣ=ϵᵣ/ϵo˜80).

The conductivity of the water leads to losses that are reflected in a parallel resistance that depends on the quantity of dissolved ions, of the order of kiloohms per meter of line with sea water and if the metal lines are electrically isolated. The parallel resistance is far lower if electrolytic conduction is able to be established between the two metal lines.

FIG. 7 is a schematic depiction of a detection module 12 according to another exemplary implementation. In this example, the module 12 also takes the form of an LC resonator. The module 12 is in this case provided with an RFID chip 121. The module 12 in this case comprises a winding 120 consisting of a plurality of conductive turns, intended to form the inductor of the LC circuit. The winding 120 is in this case connected to the terminals of the RFID chip 121. The RFID chip 121 in this case includes a capacitance (for example 23.5 pF). The capacitance of the chip 121 is insensitive or relatively insensitive to variations in the environmental parameter to be studied. The internal capacitance of the chip 121 may intrinsically be protected from the environmental parameter by one or more protective layers of this chip 121. The capacitance of the chip 121 in this case forms a fixed part of the capacitance of the LC circuit. An additional capacitor 125 is connected to the terminals of the chip 121. The additional capacitor 125 is sensitive to variations in the environmental parameter. The additional capacitor 125 may for example be brought into contact with a fluid in which it is desired to detect the variation in the environmental parameter, or else be placed in the close presence of the fluid and electrically insulated therefrom by an insulating layer of low thickness. The additional capacitor 125 may for example have a part that is not covered by a protective layer. The additional capacitor 125 in this case has a comb-shaped geometry, such that its capacitance is strongly dependent on the electrical characteristics of the nearby medium or of a fluid in contact therewith.

Provision may for example be made for the winding 120 to occupy a square with a side of 14 mm, including 19 turns formed on two faces of a substrate, the pitch of the turns being 0.4 mm and the width of the turns being 0.2 mm.

The capacitors 124 and 125 (or the capacitor of the chip 121 and the additional capacitor 125) are illustrated in parallel here. However, it is also possible to contemplate a series connection of these capacitors, for example in order to reverse the direction of transition between the two operating modes: the influence of the presence of water (in particular the presence of salt water) causes the impedance of the capacitor 125 to drop, thereby establishing a nominal operating mode with direct resonance between the inductor 123 and the capacitor 124.

The resonant frequency of the LC circuit of the module 12 in its first operating mode is advantageously close to the resonant frequency of the LC circuit of the module 11.

When the declaration module 11 is associated with a plurality of different detection modules and when it is contemplated to analyze the frequency response of the detection block 18, the various detection modules will advantageously have separate resonant frequencies.

FIGS. 8 and 9 illustrate conductor tracks that may be formed on two opposite faces of a substrate, in order to selectively form a module 12 corresponding either to the configuration from FIG. 6 or to the configuration from FIG. 7.

FIG. 8 illustrates the configuration on one face of the substrate. Pads 128 are formed between turns 122 and interdigitated tracks of an additional capacitor 125. The turns 122 belong to the winding 120. One end of the turns 122 is connected to a pad 123. Another end of the turns 122 is connected to one of the pads 128.

FIG. 9 illustrates the configuration on another face of the substrate, seen in transparency from the same viewpoint as FIG. 8. Pads 129 are formed next to turns 126. The pads 129 are opposite the pads 128. The pad 127 is opposite the pad 123. The pads 123 and 127 are electrically connected.

The opposing pads 128 and 129 are electrically connected. Connection pads that are intended to selectively connect either an RFID chip 121 or a capacitor 124 are connected to the pads 128 and 129.

To distinguish between the RFID chip 121 and the RFID chip 111 of the module 11, these advantageously have different identifiers. The modules may also be distinguished between by memories storing different information that is read by the reader 10.

The graphs in FIGS. 10 and 11 illustrate the respective frequency responses, recorded by a reader 10:
of a declaration module 11 and of a coupled detection module 12, this detection module having a resonant frequency in its second mode, for example following degradation caused by a variation in an environmental parameter;
of a declaration module 11 and of a coupled detection module 12, this detection module having a resonant frequency in its first mode, for example in the absence of a sufficient variation in an environmental parameter.

In the present scenario, the detection module 12 has a resonant frequency in its first mode that is centered on the resonant frequency of the declaration module 11. It may be seen that the frequency response for the first scenario has a simple profile corresponding to the characteristics of the LC circuit of the declaration module 11. It may be seen that the frequency response in the second scenario has a complex profile with two peaks separated by a trough, linked to the integrity of the LC circuit of the detection module 12, coupled to the LC circuit of the declaration module 11.

FIGS. 12 and 13 illustrate the respective frequency responses, recorded by a reader 10:
of a declaration module 11 and of coupled detection modules 12, these detection modules having been degraded due to a variation in an environmental parameter;
of a declaration module 11 and of coupled detection modules 12, these detection modules having been kept intact in the absence of a sufficient variation in an environmental parameter.

In the present scenario, the detection modules 12 have resonant frequencies in their first mode that are distributed on either side of the resonant frequency of the declaration module 11, for example at 13.3 MHz and 13.9 MHz for a resonant frequency of 13.6 MHz of the declaration module 11.

It may be seen that the frequency response for the first scenario has a simple profile corresponding to the characteristics of the LC circuit of the declaration module 11. It may be seen that the frequency response in the second scenario has a complex profile with peaks separated by a plurality of troughs, linked to the integrity of the LC circuits of the detection modules 12, coupled to the LC circuit of the declaration module 11.

In the above examples, the detection modules are coupled to the antenna circuit of the declaration module 11. A detection module 12 comprising an RFID chip may thus communicate with the reader 10, the antenna circuit of the declaration module serving as relay antenna. Provision may also be made for a detection module 12 comprising an RFID chip to be able to communicate independently with the reader 10.

If the reader 10 is carried by an inspection robot, the system 1 according to the invention makes it possible to decide between the following two hypotheses if no declaration module is detected:
the inspected area does not contain a detection block 18;
the inspected area contains a detection block 18 whose declaration module 11 is faulty (in which case detection modules may be accessible, but the information that they return is unusable).

If a declaration module is detected or identified, the readout device 10 may analyze the detection device in order to determine the state of the associated detection modules. The detection block 18 may be analyzed by reading its frequency response or else through an inventory of the RFID chips read by the readout device 10.

The robot may implement a step of positioning its RFID reader in front of a declaration module 11, for example by stopping at a fixed position, or by slowing down the movement of the robot, so as to have enough time to detect and analyze the closest declaration module 11 in order to analyze the detection block 18.

The reader 10 identifies the closest declaration module 11 (either directly through the response of an RFID chip of the declaration module 11 or by consulting a database identifying the declaration module 11 on the basis of the position of the reader 10). The declaration module 11 may return information relating to the detection modules 12 and 13 that are associated therewith, for example the number of detection modules that are associated therewith, their type, their identifier if they have an RFID chip, or their order in a tuning frequency distribution.

A detection module, if it has an RFID chip, may return information relating to the declaration module with which it is associated, the identification number of the declaration module for example, and information relating thereto. When each of the detection modules 12 includes an RFID chip, the reader 10 may take an inventory of the responding RFID chips so as to determine the state of each of these detection modules 12, through a comparison with the inventory of the RFID chips declared by the declaration module 11. All of the RFID chips identified in response are considered to be in nominal operating mode. By contrast, if the declaration module 11 lists a detection module 12 whose RFID chip does not respond, it may be considered that this detection module 12 has detected a variation in an environmental parameter and is in degraded operating mode.

When the detection modules 12 do not include an RFID chip, the reader 10 may perform frequency response analysis over a predefined frequency range, for example a few MHz for a center frequency of 13.56 MHz. The electromagnetic field level produced by the reader 10 in the investigation area may be changed by changing the power delivered to the antenna of the reader 10, within a given range, for example by changing from 1 W to 5 W. The electromagnetic field level produced in the investigation area may also be changed by varying the distance between the antenna of the reader 10 and the investigation area. This field level parameter may be used in the analysis of the detection block 18. It is thus possible to qualify the list of RFID chips identified through an inventory. This may be one means for revealing intermediate states of a detection module in its transition between its first mode and its second operating mode. The interpretation of the frequency response makes it possible to decide whether or not the resonator of each of the detection modules 12 is degraded.

A description has been given here of a detection system 1 consisting of a detection block 18 comprising two detection modules 12 and 13. It should be noted that the invention is in no way limited to this particular case, and could also be implemented with a detection block comprising a single detection module or more than two detection modules.

A description has been given here of a system in which the detection block 18, comprising the declaration module 11 and the one or more detection modules, may be entirely formed on a single carrier, and in which the various declaration and detection modules are not directly electrically connected. They are only coupled magnetically, thereby making it possible to isolate the declaration module 11 from the variable environment so that it is not altered by this environment, and also making it possible, if necessary, to ensure that the detection modules change from their first to their second operating mode under different environmental conditions in order to achieve better detection of the state of the environment.

1. A system for detecting an evolution of an environmental parameter, comprising:
a detection module including an LC resonant circuit sensitive to the evolution of said environmental parameter, configured to operate, depending on a value of said environmental parameter, either in a first mode in which said resonant circuit has a resonant frequency contained within a predefined range for which the detection module is able to be detected through magnetic coupling through excitation within said range, or in a second mode in which said resonant circuit has a resonant frequency outside said range or does not have a resonant frequency; and
a declaration module separate from the detection module and arranged near said detection module, configured to communicate contactlessly in near-field mode even in an event of a variation in the value of said environmental parameter, and configured to declare a presence of the detection module,
wherein, in a first configuration, the declaration module includes an LC resonant circuit including an antenna circuit for near-field contactless communication, said LC resonant circuit of the detection module including an antenna circuit coupled magnetically to the antenna circuit of the resonant circuit of the declaration module, a signature of a frequency response of the antenna circuit of the declaration module being different depending on the first or the second mode of the resonant circuit of the detection module, and
wherein, in a second configuration, the detection module includes a radiofrequency identification chip connected to the LC resonant circuit and an antenna circuit configured so as to communicate contactlessly in near-field mode, wherein said declaration module includes an LC resonant circuit including an antenna circuit for near-field contactless communication and the declaration module includes a radiofrequency identification chip connected to the LC resonant circuit and storing an identifier of the detection module.

2. The detection system as claimed in claim 1, wherein the LC resonant circuit of the detection module comprises an electrical element in contact with a surrounding fluid and configured to have its electrical properties modified based on the value of the environmental parameter in the fluid with which it is in contact.

3. The detection system as claimed in claim 2, wherein the declaration module is covered by a protective element that does not cover said electrical element of the LC resonant circuit of the detection module.

4. The detection system as claimed in claim 2, wherein the electrical element is a capacitor whose conductive or dielectric parts are configured to be altered by a variation in the value of the environmental parameter.

5. The detection system as claimed in claim 4, wherein said capacitor comprises interdigitated conductor tracks.

6. The detection system as claimed in claim 1, in the second configuration, further comprising:
a near-field contactless reader configured to retrieve the identifier of the detection module stored in the declaration module, request the provision of the identifier of the detection module by said detection module, and determine whether the detection module is in its first mode or in its second mode based on a response or absence of a response from the detection module.

7. The detection system as claimed in claim 6, wherein the contactless reader requests the provision of the identifier of said detection module according to a plurality of applied field levels.

8. A system, comprising:
a flexible pipe, and
the detection system as claimed in claim 1,
wherein said detection module and said declaration module are fixed in a thickness of the pipe near its outer surface.

9. The system as claimed in claim 8, wherein said detection system includes a readout device configured to move along a face of the flexible pipe.
